(19) United States
(12) Patent Application Publication
(10) Pub. No.: US 2011/0311231 A1
(43) Pub. Date: Dec. 22, 2011

(54) SUBMERSIBLE VESSEL DATA COMMUNICATIONS SYSTEM

(75) Inventors: Richard W. Ridgway, Westerville, OH (US); David W. Nippa, Dublin, OH (US); Stephen Yen, Columbus, OH (US); Thomas J. Barnum, Columbus, OH (US)

(73) Assignee: BATTELLE MEMORIAL INSTITUTE, Columbus, OH (US)

(21) Appl. No.: 13/203,275

(22) PCT Filed: Feb. 26, 2010
(86) PCT No.: PCT/US2010/025483

§ 371 Date: Sep. 7, 2011

Related U.S. Application Data
(60) Provisional application No. 61/155,768, filed on Feb. 26, 2009.

(51) Int. Cl. H04B 10/00

(52) U.S. Cl. 398/104

(57) ABSTRACT

A data communications system is provided comprising a submersible home vessel, a submersible satellite vessel, and a flexible dielectric waveguide cable. The flexible dielectric waveguide cable comprises an exposed dielectric face configured to transmit electromagnetic millimeter wave radiation. The submersible home vessel comprises a transparent pressure boundary that is configured to be functionally transparent to electromagnetic millimeter wave radiation and to permit unguided propagation of the electromagnetic millimeter wave radiation. The submersible home vessel further comprises a coupling portion that is configured to secure the dielectric face in a position that enables the transmission of unguided millimeter wave radiation across the transparent pressure boundary to a MMW detector within the submersible home vessel. Additional embodiments are disclosed and claimed.

The present invention relates to data communication and, more specifically, to components for facilitating data communication in applications where communication by conventional means are less than satisfactory.

For example, and not by way of limitation, in the context of underwater vehicles, like a submarine and an unmanned scout, the unmanned scout can be used collect information for transmission back to the submarine. The transmission is most effective if it supports relatively high data rates. Optical based technologies have achieved data rates in excess of 1 Gb/s but would require precisely aligned optical connectors with reasonably clean interfaces. The present inventors have recognized that millimeter-wave communication systems employing for example, a millimeter wave (MMW) generator/modulator of the type described in published US Patent App. No. US 2008/0199124 A1, with carrier frequencies between 35 GHz and 140 GHz, can support data rates in excess of 10 Gb/s and, although millimeter-waves in general are strongly attenuated when propagating through water, a millimeter-wave signal can propagate a few millimeters through water and can be used to provide a high data rate link without requiring intimate contact, clear water, a clean window, or precise alignment.

More specifically, the present inventors have explored the propagation of millimeter-waves through thin layers of sea water in the context of bio-fouled connector surfaces and connector materials of MMW data couplings and have concluded that a 35 GHz carrier, the attenuation of which is about 16.5 dB/mm in water, can support data rates up to about 5 Gb/s with relatively simple on-off keying modulation schemes and higher data rates with spectrally efficient modulation schemes such as, for example, quadrature amplitude modulation. Similarly, a 94 GHz carrier, the attenuation of which is about 35.1 dB/mm in water, can support data rates of 10 Gb/s with on-off key modulation. The present disclosure relies on photonic approaches for generating, modulating, and detecting millimeter waves, as presented in US Patent App. Nos. US 2008/0199124 A1, US 2009/0016729 A1, US 2008/0023632, and other similar publications, in the construction of data communications systems configured for reliable data transfer through water and other environments where the ambient would otherwise interfere with efficient data transfer.

In accordance with one embodiment of the present invention, a data communications system is provided comprising a submersible home vessel, a submersible satellite vessel, and a flexible dielectric waveguide cable. The flexible dielectric waveguide cable comprises an exposed dielectric face configured to transmit electromagnetic millimeter wave radiation. The submersible home vessel comprises a transparent pressure boundary that is configured to be functionally transparent to electromagnetic millimeter wave radiation and to permit unguided propagation of the electromagnetic millimeter wave radiation. The submersible home vessel further comprises a coupling portion that is configured to secure the dielectric face in a position that enables the transmission of unguided millimeter wave radiation across the transparent pressure boundary to a MMW detector within the submersible home vessel.

In accordance with another embodiment of the present invention, a submersible vessel comprising a hull, a transparent pressure boundary, a connector coupling portion, and a MMW detector is contemplated. Additional embodiments are disclosed and contemplated.

The following detailed description of specific embodiments of the present disclosure can be best understood when read in conjunction with the following drawings, where like structure is indicated with like reference numerals and in which:

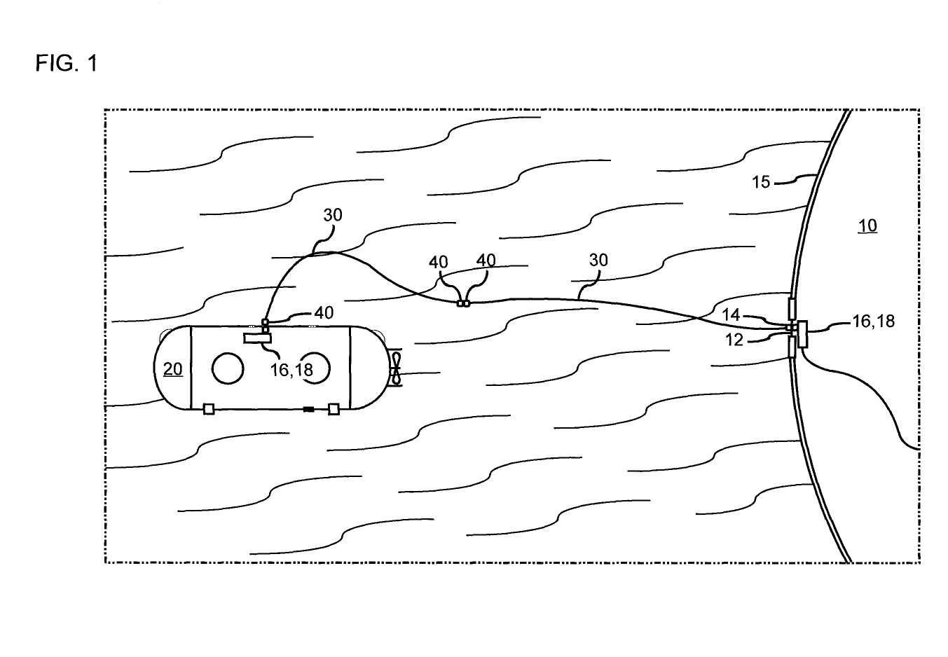

FIG. 1 is a schematic illustration of a data communications system according to one embodiment of the present disclosure;

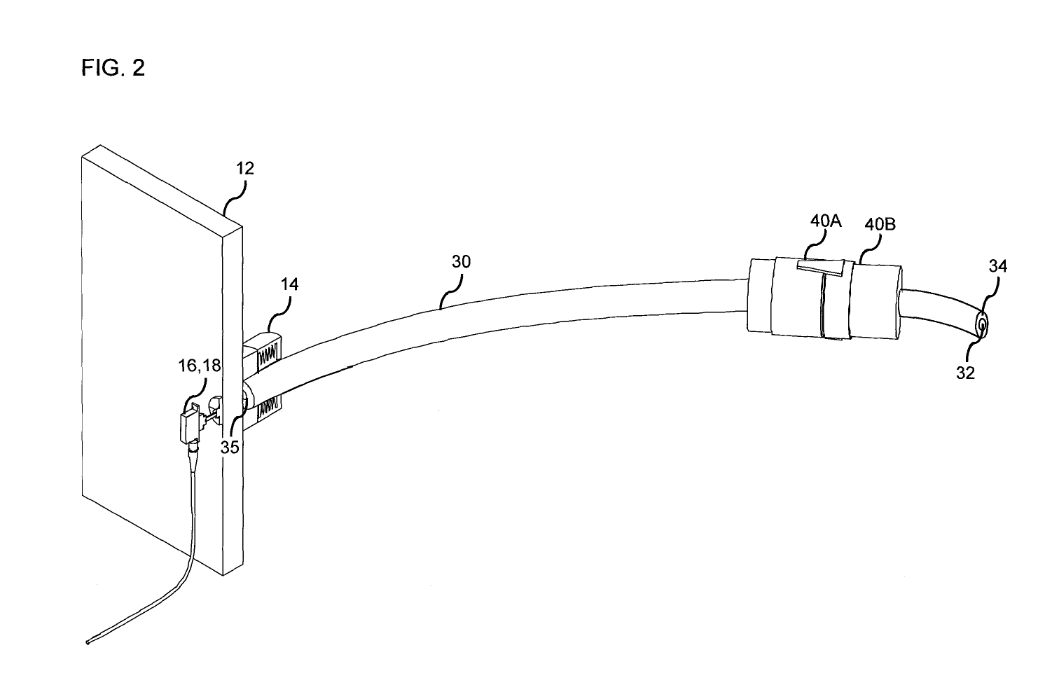

FIG. 2 is a more detailed illustration of particular components of the data communications system illustrated in FIG. 1; and

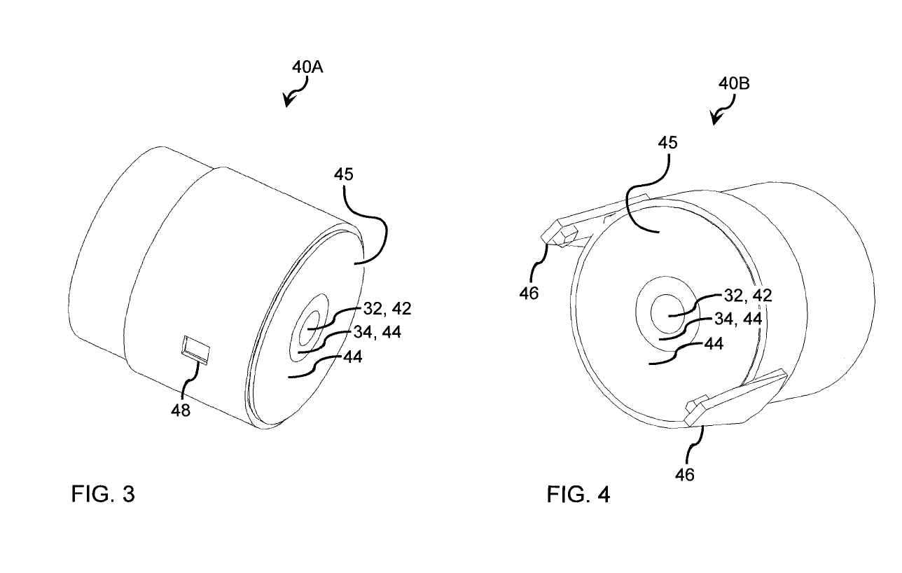

FIGS. 3 and 4 are detailed illustrations of complementary wet-mate connectors that can be utilized in a data communications system according to the present disclosure.

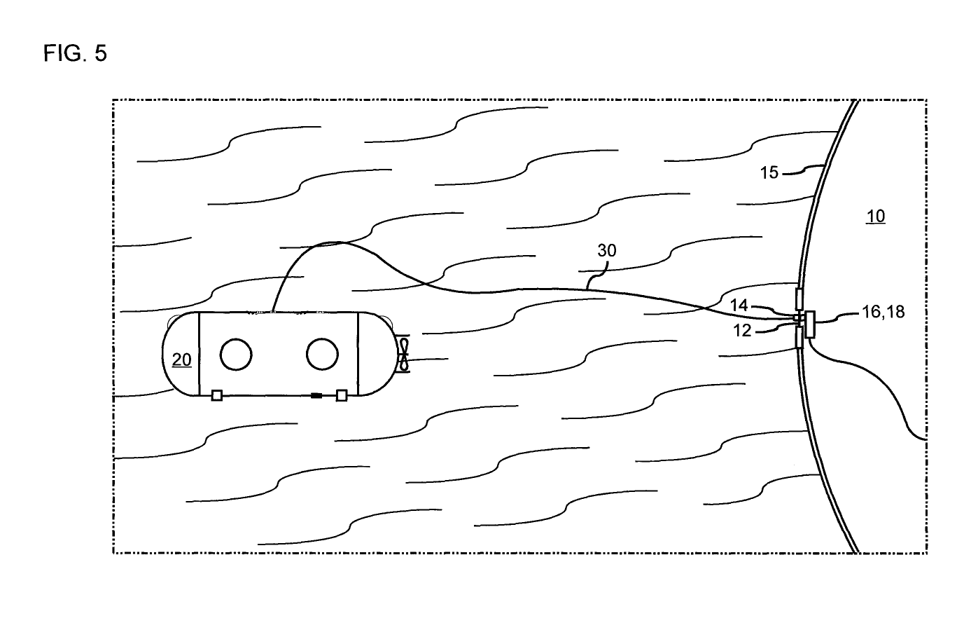

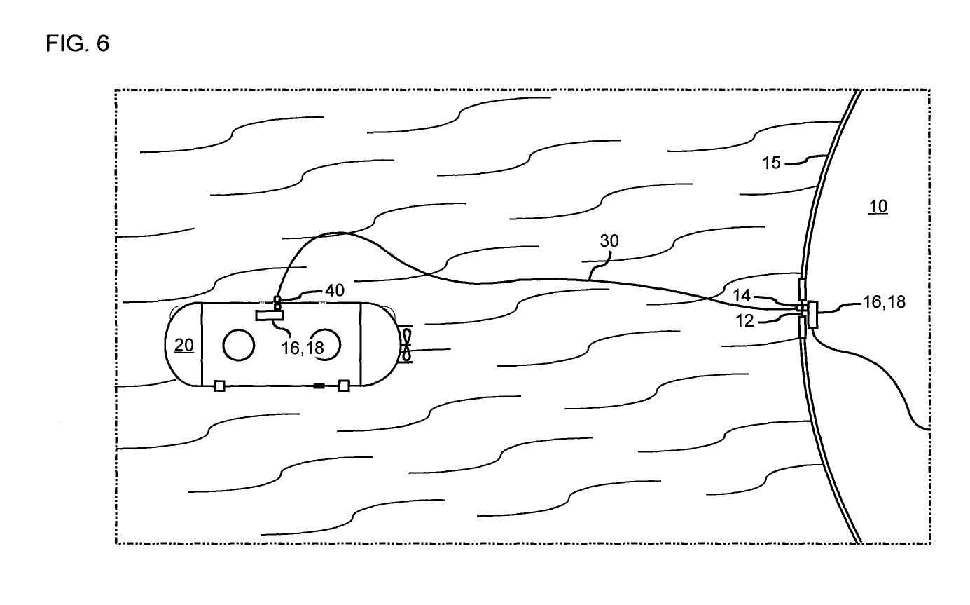

FIGS. 5 and 6 are schematic illustrations of some of the contemplated alternatives to the data communications system illustrated in FIG. 1.

A data communications system according to one embodiment of the present disclosure is illustrated schematically in FIG. 1. Generally, the system comprises a submersible home vessel 10, e.g., a military or research class submarine, a submersible satellite vessel 20, and a flexible dielectric waveguide cable 30. For the purposes of describing and defining the present invention, it is noted that a “flexible” dielectric cable is characterized by a degree of flexibility that is sufficient to permit the cable to bend, flex, or otherwise assume a serpentine, non-linear, unbroken configuration under its own weight, as the two ends of the cable move relative to one another.

The flexible dielectric waveguide cable 30 comprises one or more exposed dielectric faces that are described in further detail below and are generally configured to transmit electromagnetic millimeter wave radiation originating from the submersible home vessel 10 or the submersible satellite vessel 20. The submersible home vessel 10 illustrated in FIG. 1 comprises a transparent pressure boundary 12 that is configured to be functionally transparent to electromagnetic millimeter wave radiation and to permit unguided propagation of the electromagnetic millimeter wave radiation. The unguided MMW signal is captured by core and cladding portions of the exposed dielectric faces of the flexible dielectric waveguide cable 30. Since the signal through the transparent pressure boundary 12 is not guided, it will diverge and the size of the propagating mode will grow. Accordingly, it will often be preferable to ensure that the millimeter wave source that launches a signal on the transmit side in the submersible home vessel 10 or the submersible satellite vessel 20 will define a mode cross section that is smaller than the waveguide cross section defined by the flexible dielectric waveguide cable 30. By making the cross sectional dimension of the dielectric waveguide similar to the mode of the diverging MMW signal, the dielectric waveguide 30 will efficiently capture the signal and then propagate it in a guided mode. At the receiving end, the MMW signal starts from the dielectric waveguide 30 and diverges to a larger diameter. A MMW antenna, MMW feed, or other type of MMW detector configuration then captures the diverging MMW signal after it propagates through the transparent boundary.

The submersible home vessel 10 further comprises a connector coupling portion 14 that is configured to secure an exposed dielectric face of the cable 30 in a position that enables the transmission of unguided millimeter wave radiation across the functionally transparent pressure boundary 12 to a MMW detector 16 within the submersible home vessel. The submersible satellite vessel 20 may also comprise a transparent pressure boundary, connector coupling portion, and MMW detector.

In the embodiment illustrated in FIG. 1, the data communications system comprises a plurality of flexible dielectric waveguide cables 30, each of which comprises one or more exposed dielectric faces. In FIG. 1, the exposed dielectric face is presented in the form of an exposed dielectric face of an exposed MMW connector 40 and is illustrated in further detail below with respect to FIGS. 3 and 4. In FIG. 2, the exposed dielectric face is presented in the form of an exposed dielectric cable face 35. In either case, one of the flexible dielectric waveguide cables 30 comprises a pair of exposed dielectric faces, each at an opposite end of the flexible dielectric waveguide cable 30.

For the purposes of describing and defining the present invention, it is noted that an “exposed” dielectric face is exposed to the ambient prior to coupling with a MMW receiving element, such as a complementary MMW connector or a transparent pressure boundary. It is contemplated that the degree or duration of exposure may vary from a relatively brief, partial exposure to a relatively extended, full exposure. In any case, the exposure will be sufficient for elements in the ambient, e.g., water, sea water, bio-contaminants, etc., to reach the dielectric face prior to coupling with the MMW receiving element.

In FIG. 2, one of the pair of exposed dielectric faces is secured by the connector coupling portion 14 of the submersible home vessel 10 so that it is in MMW communication with the MMW detector 16 via the transparent pressure boundary 12. It is contemplated that connector coupling portions 14 according to the present disclosure can be configured to secure an end portion of a flexible dielectric waveguide cable 30 into direct or indirect MMW communication with the transparent pressure boundary 12. The connector coupling portion 14, which is merely illustrated schematically in FIG. 1 can alternatively be configured to secure an exposed MMW connector assembly of the type illustrated in FIGS. 3 and 4 into direct or indirect MMW communication with the transparent pressure boundary 12. In either case, the connector coupling portion can be mechanically coupled to the transparent pressure boundary 12, mounted to the transparent pressure boundary 12, or formed integrally with the transparent pressure boundary 12.

As is illustrated schematically in FIGS. 1 and 2, the submersible home vessel 10 comprises a hull 15 and the transparent pressure boundary defines a portion of the submersible home vessel 10 that is structurally distinct from the hull 15. The boundary itself should be a dielectric material and can be selected, for example, from PTFE, polystyrene, polyethylene, alumina, lithium niobate, silicon, and combinations thereof. For the purposes of describing and defining the present invention, it is noted that a “pressure boundary” of a submersible vessel is a structural member of the vessel that is capable of defining a pressure boundary between the interior of the vessel and the ambient in which the vessel is submerged. Further, a “functionally” transparent pressure boundary will be sufficiently transparent to enable transmission and corresponding detection of MMW radiation through the boundary with no more than 10 dB signal attenuation.

FIG. 2 presents a detailed illustration of one suitable manner for configuring the connector coupling portion 14. In the illustrated embodiment, the connector coupling portion 14 comprises a threaded mechanical coupling that is configured to secure an end portion of the flexible dielectric waveguide cable 30 in position, e.g., in much the same manner as a ferrule assembly. It is also contemplated that the connector coupling portion 14 can be configured for magnetic securement or any other type of mechanical or non-mechanical securement and may cooperate with portions of an associated exposed MMW connector in these respects.

As is illustrated in FIGS. 2-4, complementary exposed MMW connectors 40A, 40B may be provided such that they comprise complementary mating portions in the form of, for example, flexible latches 46 and latch receiving slots 48, that permit the flexible dielectric waveguide cables 30 to be connected to each other in series to define a MMW transmission path extending along the flexible dielectric waveguide cables 30 between the submersible home vessel 10 and the submersible satellite vessel 20.

As is illustrated in FIGS. 2-4, the exposed MMW connectors 40A, 40B each comprise a exposed dielectric connector face 45 and the flexible latches 46 and latch receiving slots 48 are configured for secure, releasable abutment of the dielectric faces 45. Typically, the aforementioned abutment of the dielectric faces 45 permits an average interfacial spacing of less than approximately 1 mm The structure of the exposed MMW connectors 40A, 40B and the nature in which the electromagnetic millimeter wave radiation is transmitted allows for relaxed engagement tolerances as compared to conventional optical transmission, e.g., on the order of not less than approximately 0.1 mm.

Electromagnetic waves in the millimeter wave region can be conveyed through dielectric transmission lines. Such transmission lines utilize dielectric materials either partially or entirely as the medium for conveying the electromagnetic waves. The flexible dielectric waveguide cable 30 illustrated in FIG. 2 comprises a cable core 32 that is characterized by a relatively high permittivity (e.g., permittivity E above about 4) and a cable cladding 34 that is characterized by a relatively low permittivity (e.g., permittivity E below about 3). In this manner, electromagnetic millimeter wave radiation propagating along the cable 30 can be confined in the flexible dielectric waveguide cable 30. For the purposes of describing and defining the present invention, it is noted that electromagnetic radiation that is “confined” in a flexible dielectric waveguide cable or a cable connector, is “confined” in the sense that a majority of the signal will propagate along the axial direction of the cable or connector, as opposed to being permitted to expand beyond the periphery of the cable or connector. For example, in the context of electromagnetic millimeter wave radiation propagating in a flexible dielectric waveguide cable, the aforementioned core and cladding combination serves to confine the millimeter-wave to the cable and control its direction of propagation along the axis of the cable.

The conditions for single-mode waveguide operation of a flexible dielectric waveguide cable according to the present disclosure can be represented as follows for a given core diameter:

$$D = \frac{{c}_{o} {V}_{c}}{f π \sqrt{{ɛ}_{core} - {ɛ}_{clad}}}$$

where cₒ is the speed of light in a vacuum, V_{c} (2.405) is the unit-less single-mode waveguide cutoff parameter (e.g., V_{c}=2.405), f is the frequency of operation, and ε_{core} and ε_{clad} are the core and cladding relative permittivities, respectively. For example, a dielectric waveguide with a core permittivity of 4 is single-mode for core a diameter of 1.5 mm within W-band operating frequencies (75 GHz to 110 GHz). Beam propogation modeling reveals that the MMW field of flexible dielectric waveguide cables according to the present disclosure will extends to a diameter of about 8 mm Therefore, a single dielectric cable could be formed with multiple cores spaced at a pitch of 8 mm

Referring to FIGS. 3 and 4, the complementary exposed MMW connectors 40A, 40B illustrated therein each comprise a connector core 42 that is contiguous with the cable core 32 and is characterized by a relatively high permittivity. The complementary exposed MMW connectors 40A, 40B further comprise a connector cladding 44 that is characterized by a relatively low permittivity. In this manner, electromagnetic millimeter wave radiation propagating from the cable 30 to the connector 40A, 40B is confined in the connector. As is illustrated in FIGS. 2-4, the connector cladding 44 defines transverse dimensions that are expanded relative to corresponding transverse dimensions of the cable cladding 34 such that the expanded cladding portion of the connector cladding 44 defines a majority of the surface area of the dielectric face 45. Although the exposed dielectric connector faces 45 illustrated in FIGS. 3 and 4 are substantially planar it is contemplated that complementary exposed MMW connectors may also comprise non-planar or keyed dielectric faces that would also be complementary. In most cases, to enable effective use and manipulation of the connectors 40A, 40B, the exposed MMW connectors 40A, 40B will be constructed to exhibit an axial rigidity that is at least one order of magnitude greater than that of the flexible dielectric waveguide cable 30.

It is also contemplated that a variety of alternative cable configurations can be practiced within the spirit of the present disclosure including, but not limited to, the configurations illustrated in FIGS. 5 and 6. For example, referring to FIG. 5, it is contemplated that a flexible dielectric waveguide cable 30 can extend directly from the submersible satellite vessel 20 to an exposed MMW connector 40 where millimeter wave radiation is transmitted across the transparent pressure boundary 12 to the MMW detector 16. Alternatively, as is illustrated in FIG. 6, the flexible dielectric waveguide cable 30 may comprise a pair of exposed MMW connectors 40, each at an opposite end of the flexible dielectric waveguide cable 30. In which case, the submersible satellite vessel 20 could comprise an additional transparent pressure boundary configured to be functionally transparent to electromagnetic millimeter wave radiation and to permit unguided propagation of the electromagnetic millimeter wave radiation. In addition, referring to FIG. 6, the submersible satellite vessel 20 may further comprises an additional connector coupling portion configured to secure the exposed MMW connector 40 in a position that enables the transmission of unguided millimeter wave radiation across the additional transparent pressure boundary to a MMW detector 16 on board the submersible satellite vessel 20.

Turning to the construction of the flexible dielectric waveguide cable 30, it is contemplated that the cable core 32 may comprise ceramic particles dispersed in a dielectric matrix. For example, the dielectric matrix may comprise a relatively low permittivity material selected from PTFE, polystyrene, polyethylene, and combinations thereof. The ceramic particles may comprise a relatively high permittivity material selected from alumina, lithium niobate, silicon, and combinations thereof. In practice, the ceramic particles occupy between approximately 5 wt % and approximately 20 wt % of the cable core and are preferably characterized by an average maximum dimension that is less than approximately 10% of the wavelength of the electromagnetic millimeter wave radiation. For example, when the electromagnetic millimeter wave radiation comprises a 300 GHz signal characterized by a wavelength of 1 mm, the ceramic particles preferably exhibit an average maximum dimension of less than 100 um. Similarly, for a 94 GHz signal characterized by a wavelength of 3.3 mm, the ceramic particles preferably exhibit an average maximum dimension of less than 330 μm.

More specifically, in one embodiment, the cable core 32 is constructed by dispersing 18 wt % alumina (ε=9.8) in a PTFE matrix (ε=2.1) to achieve a resulting core permittivity of approximately 3.5. The core diameter is approximately 2 mm and the cladding is 100% PTFE defining a diameter of about 10 mm In practicing the concepts of the present disclosure, it is noted that respective components of the core and cladding can be controlled to vary the resulting core and cladding dimensions and permittivity.

For the purposes of describing and defining the present invention, it is noted that reference herein to a “millimeter” wave is intended to encompass electromagnetic radiation in the highest radio frequency band, i.e., from about 30 to about 300 gigahertz, also referred to as terahertz radiation. This band has a wavelength of ten to one millimeter, giving it the name millimeter band or millimeter wave, sometimes abbreviated MMW or mmW.

The MMW detector 16 is illustrated schematically in FIGS. 1 and 2 and may comprise any of a number of suitable detectors responsive to electromagnetic millimeter wave radiation. For example, the MMW detector may be constructed by positioning a millimeter-wave preamplifier downstream of a MMW antenna and by positioning a

Schottky-diode-based millimeter-wave detector downstream of the preamplifier. Signal processing can be enabled by providing a clock and data recovery circuit.

For the purposes of describing and defining the present invention, it is noted that reference herein to a variable being a “function” of a parameter or another variable is not intended to denote that the variable is exclusively a function of the listed parameter or variable. Rather, reference herein to a variable that is a “function” of a listed parameter is intended to be open ended such that the variable may be a function of a single parameter or a plurality of parameters.

It is also noted that recitations herein of “at least one” component, element, etc., should not be used to create an inference that the alternative use of the articles “a” or “an” should be limited to a single component, element, etc.

It is noted that recitations herein of a component of the present disclosure being “configured” in a particular way, to embody a particular property, or to function in a particular manner, are structural recitations, as opposed to recitations of intended use. More specifically, the references herein to the manner in which a component is “configured” denotes an existing physical condition of the component and, as such, is to be taken as a definite recitation of the structural characteristics of the component.

It is noted that terms like “preferably,” “commonly,” and “typically,” when utilized herein, are not utilized to limit the scope of the claimed invention or to imply that certain features are critical, essential, or even important to the structure or function of the claimed invention. Rather, these terms are merely intended to identify particular aspects of an embodiment of the present disclosure or to emphasize alternative or additional features that may or may not be utilized in a particular embodiment of the present disclosure.

For the purposes of describing and defining the present invention it is noted that the terms “substantially” and “approximately” are utilized herein to represent the inherent degree of uncertainty that may be attributed to any quantitative comparison, value, measurement, or other representation. The terms “substantially” and “approximately” are also utilized herein to represent the degree by which a quantitative representation may vary from a stated reference without resulting in a change in the basic function of the subject matter at issue.

Having described the subject matter of the present disclosure in detail and by reference to specific embodiments thereof, it is noted that the various details disclosed herein should not be taken to imply that these details relate to elements that are essential components of the various embodiments described herein, even in cases where a particular element is illustrated in each of the drawings that accompany the present description.

Rather, the claims appended hereto should be taken as the sole representation of the breadth of the present disclosure and the corresponding scope of the various inventions described herein. Further, it will be apparent that modifications and variations are possible without departing from the scope of the invention defined in the appended claims. More specifically, although some aspects of the present disclosure are identified herein as preferred or particularly advantageous, it is contemplated that the present disclosure is not necessarily limited to these aspects.

It is noted that one or more of the following claims utilize the term “wherein” as a transitional phrase. For the purposes of defining the present invention, it is noted that this term is introduced in the claims as an open-ended transitional phrase that is used to introduce a recitation of a series of characteristics of the structure and should be interpreted in like manner as the more commonly used open-ended preamble term “comprising.”

1. A data communications system comprising a submersible home vessel, a submersible satellite vessel, and a flexible dielectric waveguide cable, wherein:
the flexible dielectric waveguide cable comprises an exposed dielectric face configured to transmit electromagnetic millimeter wave radiation;
the submersible home vessel comprises a transparent pressure boundary that is configured to be functionally transparent to electromagnetic millimeter wave radiation and to permit unguided propagation of the electromagnetic millimeter wave radiation; and
the submersible home vessel further comprises a coupling portion that is configured to secure the dielectric face in a position that enables the transmission of unguided millimeter wave radiation across the transparent pressure boundary to a MMW detector within the submersible home vessel.

2. A data communications system as claimed in claim 1 wherein:
the data communications system further comprises a millimeter wave source that is configured to launch an electromagnetic millimeter wave signal on a transmit side in the submersible home vessel or the submersible satellite vessel; and
the millimeter wave source defines a signal mode cross section that is smaller than the waveguide cross section defined by the flexible dielectric waveguide cable.

3. A data communications system as claimed in claim 1 wherein the flexible dielectric waveguide cable comprises an exposed MMW connector comprising a dielectric face configured to transmit electromagnetic millimeter wave radiation.

4. A data communications system as claimed in claim 1 wherein the flexible dielectric waveguide cable comprises a cable core characterized by permittivity ε above about 4 and a cable cladding characterized by a permittivity ε below about 3 such that electromagnetic millimeter wave radiation propagating along the cable is confined in the cable.

5. A data communications system as claimed in claim 4 wherein the cable core comprises a dielectric matrix and ceramic particles dispersed in the dielectric matrix.

6. A data communications system as claimed in claim 5 wherein the cable core comprises between approximately 5 wt % and approximately 20 wt % ceramic particles.

7. A data communications system as claimed in claim 5 wherein the ceramic particles are characterized by an average maximum dimension that is less than approximately 10% of the wavelength of the electromagnetic millimeter wave radiation.

8. A data communications system as claimed in claim 5 wherein the electromagnetic millimeter wave radiation comprises:
a 300 GHz signal characterized by a wavelength of 1 mm and the ceramic particles exhibit an average maximum dimension of less than 100 μm; or
a 94 GHz signal characterized by a wavelength of 3.3 mm and the ceramic particles exhibit an average maximum dimension of less than 330 μm.

9. A data communications system as claimed in claim 4 wherein:
the flexible dielectric waveguide cable comprises an exposed MMW connector;
the exposed MMW connector comprises a dielectric face configured to transmit electromagnetic millimeter wave radiation, a connector core characterized by a relatively high permittivity, and a connector cladding characterized by a relatively low permittivity such that electromagnetic millimeter wave radiation propagating from the cable to the exposed MMW connector is confined in the connector; and
the connector cladding defines transverse dimensions that are expanded relative to corresponding transverse dimensions of the cable cladding such that the expanded cladding portion of the connector cladding defines a majority of the surface area of the dielectric face.

10. A data communications system as claimed in claim 1 wherein:
the data communications system comprises a plurality of flexible dielectric waveguide cables, each of which comprises at least one exposed MMW connector comprising an exposed dielectric connector face; and
the exposed MMW connectors comprise complementary mating portions that permit the flexible dielectric waveguide cables to be connected to each other in series to define a MMW transmission path extending along the flexible dielectric waveguide cables between the submersible home vessel and the submersible satellite vessel.

11. A data communications system as claimed in claim 10 wherein:
the exposed MMW connectors each comprise an exposed dielectric connector face; and
the complementary mating portions of the exposed MMW connectors are configured for abutment of the exposed dielectric connector faces.

12. A data communications system as claimed in claim 11 wherein the abutment of the dielectric faces permits an average interfacial spacing of less than approximately 1 mm

13. A data communications system as claimed in claim 10 wherein:
the flexible dielectric waveguide cable comprises a cable core characterized by a relatively high permittivity and a cable cladding characterized by a relatively low permittivity such that electromagnetic millimeter wave radiation propagating along the cable is confined in the flexible dielectric waveguide cable;
the exposed MMW connectors each comprise an exposed dielectric connector face, a connector core characterized by a relatively high permittivity, and a connector cladding characterized by a relatively low permittivity such that electromagnetic millimeter wave radiation propagating from the cable to the connector is confined in the connector; and
the connector cladding defines transverse dimensions that are expanded relative to corresponding transverse dimensions of the cable cladding such that the expanded cladding portion of the connector cladding defines a majority of the surface area of the exposed dielectric connector face.

14. A data communications system as claimed in claim 10 wherein:
the exposed MMW connectors each comprise an exposed dielectric connector face; and
the complementary mating portions of the exposed MMW connectors comprise complementary latches and receiving slots configured for an engagement tolerance of not less than approximately 0.1 mm.

15. A data communications system as claimed in claim 10 wherein:
one of the flexible dielectric waveguide cables comprises a pair of exposed dielectric faces, each at an opposite end of the flexible dielectric waveguide cable; and
one of the pair of exposed dielectric faces is secured by the connector coupling portion of the submersible home vessel.

16. A data communications system as claimed in claim 1 wherein the flexible dielectric waveguide cable extends directly from the submersible satellite vessel to the exposed dielectric face where millimeter wave radiation is transmitted across the transparent pressure boundary.

17. A data communications system as claimed in claim 1 wherein:
the flexible dielectric waveguide cable comprises a pair of exposed dielectric faces, each at an opposite end of the flexible dielectric waveguide cable; and
the submersible satellite vessel comprises an additional transparent pressure boundary that is configured to be functionally transparent to electromagnetic millimeter wave radiation; and
the submersible satellite vessel further comprises an additional connector coupling portion that is configured to secure one of the exposed dielectric faces in a position that enables the transmission of unguided millimeter wave radiation across the additional transparent pressure boundary.

18. A data communications system as claimed in claim 1 wherein the connector coupling portion is mechanically coupled to the transparent pressure boundary, mounted to the transparent pressure boundary, or formed integrally with the transparent pressure boundary.

19. A data communications system as claimed in claim 1 wherein the submersible home vessel comprises a hull and the transparent pressure boundary defines a portion of the submersible home vessel that is structurally distinct from the hull.

20. A submersible vessel comprising a hull, a transparent pressure boundary, a connector coupling portion, and a MMW detector, wherein:
the transparent pressure boundary defines a portion of the submersible home vessel that is structurally distinct from the hull and is configured to be functionally transparent to electromagnetic millimeter wave radiation;
the MMW detector is positioned to detect electromagnetic millimeter wave radiation transmitted through the transparent pressure boundary; and
the connector coupling portion is configured to secure an exposed dielectric face in a position that enables the transmission of unguided millimeter wave radiation across the transparent pressure boundary to the MMW detector within the submersible home vessel.
